(19) United States
(12) Patent Application Publication
(10) Pub. No.: US 2026/0095528 A1
(43) Pub. Date: Apr. 2, 2026

(54) IMAGE FORMING APPARATUS AND DISPLAY METHOD

(71) Applicant: SHARP KABUSHIKI KAISHA, Osaka (JP)

(72) Inventor: KAZUHIKO IDO, Osaka (JP)

(21) Appl. No.: 19/335,151

(22) Filed: Sep. 22, 2025

(30) Foreign Application Priority Data
Sep. 27, 2024 (JP) 2024-168839

(51) Int. Cl. H04N 1/00; B08B 1/10; B08B 1/30; G03G 15/00; G03G 21/16

(52) U.S. Cl. CPC H04N 1/00074; B08B 1/10; B08B 1/30; G03G 15/5016; G03G 15/55; G03G 15/70; G03G 21/1633; H04N 1/00015; H04N 1/00037; H04N 1/00082; H04N 1/00909; H04N 2201/0094

(57) ABSTRACT

An image forming apparatus that includes a sensor, a cleaning mechanism that cleans the sensor, a display, a job executor, a detector that detects contamination on the sensor, and one or more controllers that control display of a notification related to the cleaning of the sensor on the display by operation regarding a job executed by the job executor when the detector detects contamination on the sensor.

### FIELD OF THE INVENTION

The disclosure relates to an image forming apparatus and the like.

### BACKGROUND ART

For example, there is known an image forming apparatus in which contamination with toner or the like on an optical detecting means is easily prevented, a reference image of each color is accurately detected, and a color image of high image quality is obtained by highly accurate color registration correction and density control.

### PRIOR ART DOCUMENTS

### Patent Documents

[Patent Document 1] JP 2002-131997

### SUMMARY

### Technical Problem

One of objects of the disclosure is, for example, to make it possible to control display of a message to be notified to a user in accordance with a state of an image forming apparatus when contamination on a sensor is detected.

### Solution to Problem

An image forming apparatus according to the disclosure includes a sensor, a cleaning mechanism that cleans the sensor, a display, a job executor, a detector that detects contamination on the sensor, and one or more controllers that control display of a notification related to the cleaning of the sensor on the display by operation regarding a job executed by the job executor when the detector detects contamination on the sensor.

A display method of the disclosure in an image forming apparatus including a sensor and a cleaning mechanism that cleans the sensor includes (a) displaying, (b) executing a job, (c) detecting contamination on the sensor, and (d) controlling, when the detector detects contamination on the sensor, display in step (a) of a notification related to the cleaning of the sensor, by operation regarding a job executed in step (b).

### Advantageous Effects of Disclosure

According to the disclosure, for example, it is possible to provide an image forming apparatus in which display of a message to be notified to a user can be controlled in accordance with a state of the image forming apparatus when contamination on a sensor is detected.

### BRIEF DESCRIPTION OF THE DRAWINGS

FIG. 1 is a diagram for describing an overall configuration of an image forming apparatus according to a first embodiment.

FIG. 2A is a diagram for describing an example of a state in which a cover is closed and

FIG. 2B is a diagram for describing an example of a state in which the cover is opened, in a cleaning mechanism of a sensor in the first embodiment.

FIG. 3 is a diagram for describing a hardware configuration of the image forming apparatus in the first embodiment.

FIG. 4 is a diagram for describing a software configuration of the image forming apparatus in the first embodiment.

FIG. 5 is a diagram for describing an example of flag information in the first embodiment.

FIG. 6 is a diagram for describing a processing flow in the first embodiment.

FIGS. 7A, 7B, 7C, and 7D are diagrams illustrating an operation example in the first embodiment.

FIG. 8 is a diagram for describing a processing flow in a second embodiment.

FIG. 9 is a diagram for describing an operation example in the second embodiment.

FIG. 10 is a diagram for describing a processing flow in a third embodiment.

FIG. 11 is a diagram for describing an operation example in the third embodiment.

### DESCRIPTION OF EMBODIMENTS

In general, an image forming apparatus includes a sensor for adjusting image quality. Here, for example, it is known as a technique in the related art, in an image forming apparatus in which contamination on a sensor can be cleaned along with opening and closing operations of a cover (door), to issue a message for requesting a user to perform the opening and closing operations of the cover for cleaning the sensor when contamination on the sensor is detected. For example, when detecting contamination adhering to the sensor, the image forming apparatus performed notification to the user by displaying a code indicating the contamination on the sensor or an explanatory screen, or the like. The user performed, according to the notification, a cleaning procedure (for example, opening and closing of the cover) corresponding to the code indicated in a manual or on an explanatory screen, for cleaning the sensor.

However, depending on a state of the image forming apparatus, even when contamination on the sensor was detected, the above message could not be immediately issued in some cases. For example, in a case where a copy job is being executed, an engine cannot be stopped until output is completed for a portion for which an output instruction to the engine has been completed. In a case where the message is displayed to the user here, there was a problem in that the user opens the cover by mistake at a timing inappropriate for opening and closing operations of the cover, such as during execution of the copy job.

Further, there is a case where the opening and closing operations of the cover are required due to another factor before the image forming apparatus is brought into a state of being allowed to issue the above message, and cleaning of the sensor is unintentionally completed, thus there was a problem in that a determination of whether to issue the above message or not is necessary even when the image forming apparatus is brought into the state of being allowed to issue the above message.

An image forming apparatus that addresses such a problem will be described with reference to the drawings and in accordance with the following embodiments. Note that the contents set forth in the claims will be described in the embodiments below as an example, and the technical scope of the disclosure is not limited to the following description.

### 1. First Embodiment

### 1.1 Overall Configuration

### 1.1.1 Image Forming Apparatus

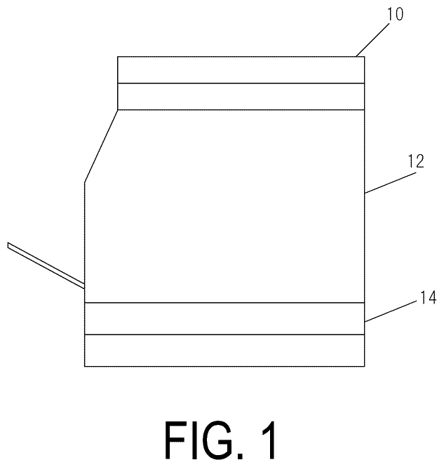

FIG. 1 is a diagram for describing an image forming apparatus 10.

The image forming apparatus 10 is an apparatus referred to as, for example, a multifunction apparatus or a Multifunction Peripheral/Printer (MFP). For example, when executing a job (print job), the image forming apparatus 10 can form an image on a sheet or the like that is a recording medium. The image forming apparatus 10 can execute various jobs, including copy processing, fax processing, scan processing, and print processing.

The image forming apparatus 10 includes a cover (cover member) 12 that can be opened and closed at a back surface thereof. The image forming apparatus 10 includes a cleaning mechanism (sensor cleaning mechanism) inside the cover 12 that cleans a sensor. A user can clean the sensor by opening and closing the cover 12 to slide the cleaning mechanism, for example. Further, when a paper jam is caused in the image forming apparatus 10, the user can open the cover 12 and remove a jammed sheet to solve the jam.

Further, the image forming apparatus 10 further includes a feeder 14. The feeder 14 includes, for example, a feed tray, a bypass tray, a sheet feeding roller for feeding a sheet to an image former 160 described below, and the like.

### 1.1.2 Cleaning Mechanism

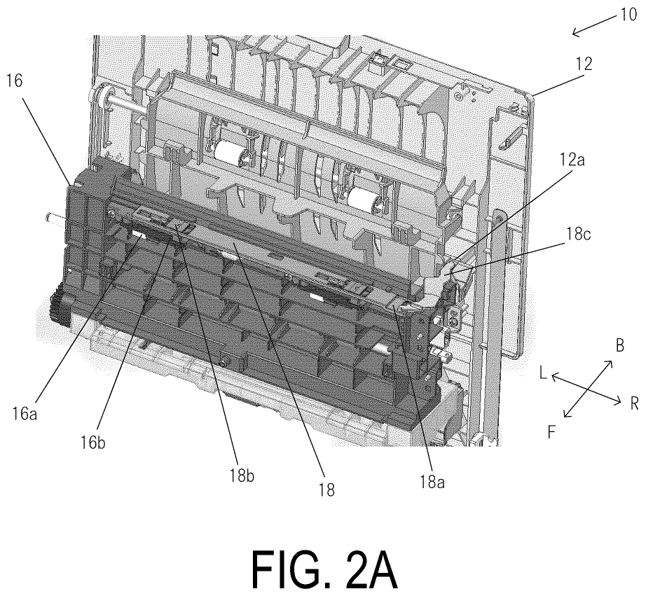

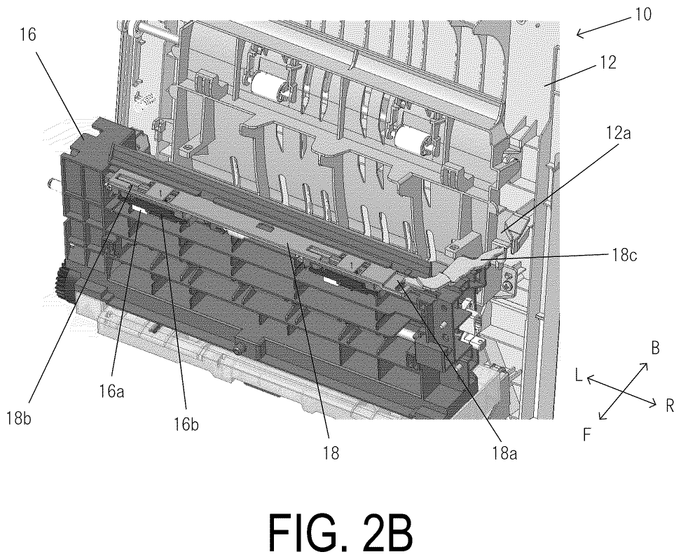

Next, the cleaning mechanism of the image forming apparatus 10 will be described with reference to FIGS. 2A and 2B. FIGS. 2A and 2B are diagrams illustrating an example of the cleaning mechanism of the image forming apparatus 10.

FIG. 2A is a perspective view for describing an example of the image forming apparatus 10 with the cover 12 closed as viewed from an inside. As illustrated in FIG. 2A, the image forming apparatus 10 includes the cover 12, a sensor holder unit 16, and a cleaning mechanism 18.

The cover 12 is connected to the image forming apparatus 10 in a state of being openable and closable, for example. The cover 12 includes, for example, a stopper member 12a with a guide. A sheet is fed from the feeder 14 to the image former 160 (from below to above) through a space between the cover 12 and the sensor holder unit 16.

For example, when a paper jam occurs during copying, the user can open the cover 12 and remove a sheet jammed between the cover 12 and the sensor holder unit 16 to solve the jam.

The sensor holder unit 16 includes, for example, a sensor 16a and a sensor holding member (sensor holder) 16b, and the sensor 16a is provided so as to face upward at the sensor holder unit 16 via the sensor holding member 16b.

The sensor 16a is one or more sensors provided for adjusting image quality, and may be, for example, a registration control sensor that detects a deviation in density of each toner image or a positional deviation, a process control sensor, or a sensor having both functions. The sensor 16a is protected by a cover glass, for example.

The cleaning mechanism 18 includes, for example, a sensor cleaning plate 18a, one or more cleaning pads 18b, and a sensor cleaning lever 18c. The sensor cleaning plate 18a is installed above the sensor 16a in a state of being slidable in a longitudinal direction (L-R direction) of the sensor holder unit 16. The sensor cleaning plate 18a may be provided with one or more small windows, for example, so as not to interfere with operation of the sensor 16a.

The cleaning pad 18b is, for example, a scraper, and is provided at the sensor cleaning plate 18a so as to abut against an end portion of the cover glass of the sensor 16a.

The sensor cleaning lever 18c is connected to the sensor cleaning plate 18a, at one end (in an F direction), for example. Furthermore, the sensor cleaning lever 18c is connected to the sensor holder unit 16 in a state in which the sensor cleaning lever 18c is rotatable. Another end (in a B direction) of the sensor cleaning lever 18c is fixed so as to be inserted into the stopper member 12a with the guide when the cover 12 is closed.

FIG. 2B is a perspective view for describing an example of the image forming apparatus 10 with the cover 12 open as viewed from the inside. As illustrated in FIG. 2B, when the cover 12 is opened, the sensor cleaning lever 18c is disengaged from the stopper member 12a with the guide. As a result, an end portion (in the B direction) of the sensor cleaning lever 18c disengaged from the stopper member 12a is rotated outward (in an R direction) by an elastic member (not illustrated here). On the other hand, another end portion (in the F direction) of the sensor cleaning lever 18c connected to the sensor cleaning plate 18a is rotated inward (in an L direction), and the sensor cleaning plate 18a slides above the sensor holder unit 16 (from the R direction to the L direction) in conjunction with the inward rotation.

As the sensor cleaning plate 18a slides, the cleaning pad 18b abutting against one end (on the R side) of the cover glass of the sensor 16a also slides to another end (on the L side) of the cover glass of the sensor 16a together with the sensor cleaning plate 18a, and scrapes off toner adhering to the cover glass of the sensor 16a, to complete the cleaning of the sensor 16a.

Note that in the present embodiment, an example of the cleaning mechanism 18 has been illustrated, but any configuration may be adopted as long as the sensor 16a can be cleaned by operating the cover 12. For example, the cover 12 may be provided not only at the back surface of the image forming apparatus 10 but also at a front surface or any of left and right side surfaces.

### 1.2 Hardware Configuration

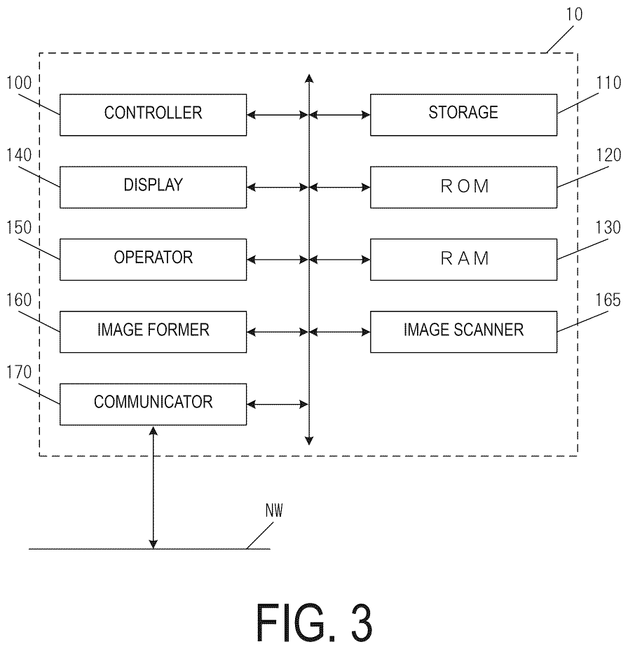

A hardware configuration of the image forming apparatus 10 will be described below with reference to the drawings. FIG. 3 is a diagram illustrating an example of the hardware configuration of the image forming apparatus 10.

As illustrated in FIG. 3, the image forming apparatus 10 includes a controller 100, a storage 110, a Read Only Memory (ROM) 120, a Random Access Memory (RAM) 130, a display 140, an operator 150, the image former 160, an image scanner 165, and a communicator 170. The storage 110, the ROM 120, and the RAM 130 serve as one or more storage apparatuses (storages).

The controller 100 controls the image forming apparatus 10 as a whole. The controller 100 enables various functions by reading and executing various programs stored in the storage apparatuses (storage 110 and ROM 120, for example). The controller 100 may be achieved by one or more control apparatuses/arithmetic apparatuses (Central Processing Unit (CPU) or System on a Chip (SoC)). The controller 100 may include one or more control circuits.

The storage 110 is a non-volatile storage apparatus capable of storing programs and data. For example, the storage 110 may include one or more storage apparatuses such as a Hard Disk Drive (HDD) or a Solid State Drive (SSD). In addition, the storage 110 may be an external apparatus such as a USB flash drive that can be connected to the image forming apparatus 10. The storage 110 may be, for example, a storage area on a cloud.

The ROM 120 is one or more non-volatile memories capable of holding the programs and data even if the power is turned off.

The RAM 130 is a main memory mainly utilized when the controller 100 executes processing. The RAM 130 is one or more rewritable memories that temporarily hold a program read from the storage 110 or the ROM 120 and data including an execution result.

The display 140 is a display apparatus that can display various types of information and various screens such as an execution screen. The display 140 may be, for example, a display apparatus such as a Liquid Crystal Display (LCD), an organic Electro-Luminescence (EL) display, or an electrophoresis display. The display 140 includes an interface to which the display apparatus can be connected. For example, the display 140 may include an external display apparatus connected via a High-Definition Multimedia Interface (HDMI; trade name), a Digital Visual Interface (DVI), or a display port.

The operator 150 is an operation apparatus that can receive operation input from the user. For example, the operator 150 may be software keys displayed on a touch panel integrated with the display 140 or hardware keys such as operation buttons. The operator 150 may be an operation apparatus such as a keyboard or a mouse, for example. The operator 150 may also include an interface (USB, for example) to which an operation apparatus can be connected. For example, the image forming apparatus 10 may be connected to different operation apparatuses (keyboard, mouse, and the like) via an interface.

The image former 160 forms an image on, for example, a recording sheet. The image former 160 includes, for example, an image carrier, and forms an image by forming a toner image on the image carrier and transferring the toner image on the image carrier onto the recording sheet. The image former 160 may be configured as an image forming apparatus such as a printer. The image former 160 may electronically form an image as an image file.

The image scanner 165 scans a document (image) and outputs the document as image data. The image scanner 165 is, for example, a scanner, and may be a scanning apparatus that utilizes a Charge Coupled Device (CCD), a Contact Image Sensor (CIS), or a Complementary Metal-oxide-Semiconductor (CMOS) image sensor.

The communicator 170 is a communication interface that communicates with other apparatuses. The communicator 170 may be, for example, a network interface capable of providing wired connection or wireless connection. In the present embodiment, communication with other apparatuses is available via a network (NW).

### 1.3 Software Configuration

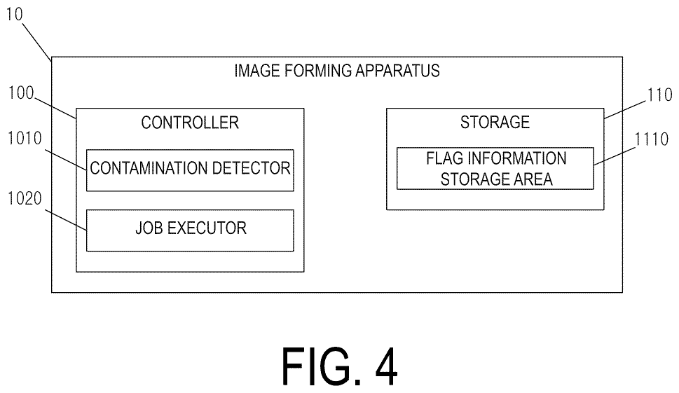

A main software configuration of the image forming apparatus 10 will be described with reference to FIG. 4. Note that the software configurations illustrated in FIG. 4 are main configurations necessary in the present embodiment, and the other configurations are not illustrated.

For example, the controller 100 can read and execute programs stored in the storage (the storage 110 and the ROM 120), and achieve a contamination detector 1010 and a job executor 1020.

The contamination detector 1010 detects contamination on the sensor, for example, contamination such as toner adhering to the cover glass of the sensor 16a. The contamination detector 1010 measures, for example, an index serving as a reference, and detects contamination on the sensor when a measurement value obtained by the measurement is less than a predetermined threshold value. When detecting contamination on the sensor 16a, the contamination detector 1010 can set a sensor cleaning flag in a flag information storage area 1110 to ON to store the detection. Here, when the number of times of detection of contamination on the sensor exceeds a predetermined number of times, an error indicating that the sensor cannot be cleaned may be notified without setting the sensor cleaning flag in the flag information storage area 1110 to ON.

The job executor 1020 executes various types of jobs. The job executor 1020 causes the image forming apparatus 10 to execute various types of operations depending on, for example, a type of job being executed. Here, the types of job refer to different types of jobs such as a copy job, a scan job, a print job, a FAX transmission job, and a FAX job. As an example of the operation that the image forming apparatus 10 is caused to execute, for example, the job executor 1020 causes the feeder 14 to operate in a case of a copy job, a print job, or a FAX job, and does not cause the feeder 14 to operate in a case of a scan job. The job executor 1020 may store information on the operation that the image forming apparatus 10 is caused to execute by executing a job as flag information in the flag information storage area 1110.

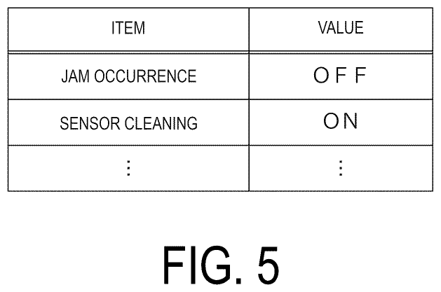

Further, the storage 110 secures an area in the flag information storage area 1110 for storing the flag information. The flag information may store information on a state of the image forming apparatus 10, for example, information on whether cleaning of the sensor 16a is necessary or not, information indicating operation by execution of a job such as whether the feeder 14 is operating or not, and information on where in the image forming apparatus 10 a jam occurs. Here, an example of the flag information stored in the flag information storage area 1110 will be described with reference to FIG. 5. The flag information stores items of various states of the image forming apparatus 10 (for example, “JAM OCCURRENCE”) and values corresponding to the items (for example, “OFF”). Here, “ON” and “OFF” can be stored as the values, and for example, in the case of the jam occurrence, “ON” may indicate that a jam is occurring, and “OFF” may indicate that a jam is not occurring.

### 1.4 Processing Flow

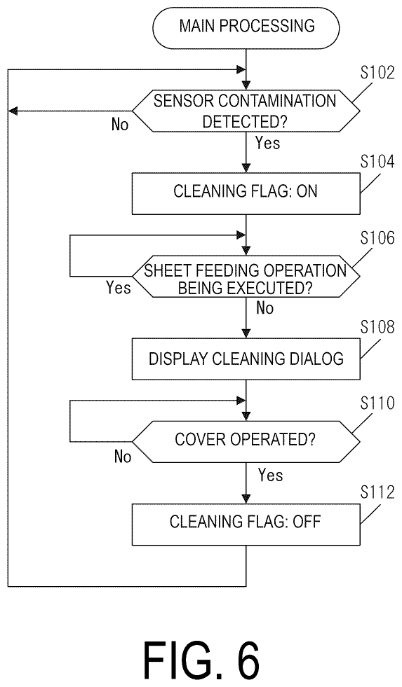

Hereinafter, a processing flow in the present embodiment will be described with reference to FIG. 6. Note that although the following processing will be described as being executed by the controller 100 of the image forming apparatus 10, the configuration described in FIG. 3 or 4 may execute the processing of each step.

First, the controller 100 determines whether contamination on the sensor 16a is detected or not (S102). The controller 100, when determining that contamination on the sensor is detected, sets the sensor cleaning flag in the flag information storage area 1110 to ON to store the determination (S102; Yes→S104), and when determining that contamination on the sensor is not detected, continues to determine whether contamination on the sensor is detected or not until contamination on the sensor is detected (S102; No).

Subsequently, the controller 100 determines whether the image forming apparatus 10 is executing an operation involving sheet feeding from the feeder 14 or not (S106). The following method is conceivable as the method of determining whether the operation involving sheet feeding from the feeder 14 is being executed or not.

As a first method, for example, when a job involving a sheet feeding operation from the feeder 14 to the image former 160, such as a copy job, a print job, or a FAX job, is executed, the controller 100 determines that the sheet feeding operation is being executed. As a second method, for example, when the feeder 14 is operating, the controller 100 determines that the sheet feeding operation is being executed. As a third method, for example, when flag information on the operation of the feeder 14 by execution of a job among flag information stored in the flag information storage area 1110 indicates that the operation is being executed, the controller 100 determines that the sheet feeding operation is being executed.

Here, when determining that the sheet feeding operation is not being executed, the controller 100 displays, for example, a notification requesting cleaning of the sensor 16a on the display 140 by a cover opening/closing request screen (display screen) (S106; No→S108). Note that the cover opening/closing request screen may be displayed as a cleaning dialog, for example. On the other hand, when the sheet feeding operation is being executed, the controller 100 continues to determine whether the sheet feeding operation is being executed or not until it is determined that the sheet feeding operation is not being executed (S106; Yes).

Next, the controller 100 may determine whether the cover 12, which is an example of a cover that can slide the cleaning mechanism in accordance with opening and closing operations of the cover, is operated or not, and, for example, when it is determined that at least an operation of opening the cover 12 is performed, the controller 100 may set the sensor cleaning flag in the flag information storage area 1110 to OFF to store the determination, erase the cover opening/closing request screen (end the display of the cover opening/closing request screen), and display a notification requesting to close the cover as a new display screen on the display 140 (S110; Yes→S112). On the other hand, the controller 100 continues to display the cover opening/closing request screen on the display 140 at least until it is determined that an operation of opening the cover 12 is performed (S110; No).

### 1.5 Operation Examples

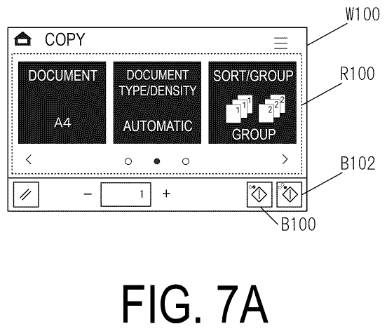

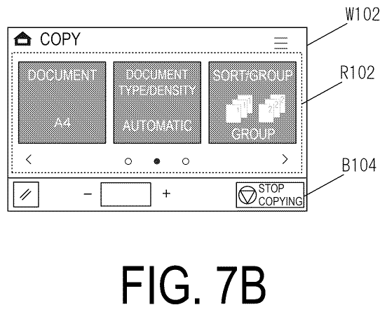

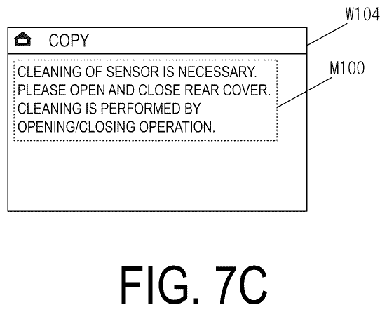

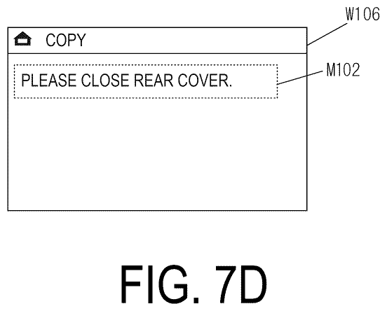

FIG. 7A is a diagram illustrating an example of a display screen W100 displayed on the display 140. The display screen W100 is a diagram illustrating an example of a display screen for setting a copy job, for example. In an area R100 on the display screen W100, as selectable icons for setting a copy job, an icon with which a document size can be selected, an icon with which a document type/density can be selected, and an icon with which a classification method (sort/group) of output sheets can be set are displayed.

Note that the icons here mean various types of data and processing functions displayed on the display screen as pictures, pictographs, symbols, and characters, for example. When the user selects the icon, the controller 100 can execute processing set for the icon.

In addition, the display screen W100 displays a monochrome copy execution button B100 and a color copy execution button B102. Here, when detecting contamination on the sensor while the display screen W100 is displayed, the controller 100 displays a display screen W104 of FIG. 7C as the cover opening/closing request screen. Here, when the user selects, for example, the monochrome copy execution button B100 or the color copy execution button B102 while the display screen W100 is displayed, the controller 100 executes a monochrome copy job or a color copy job, respectively, and displays a display screen W102 of FIG. 7B.

FIG. 7B is a diagram illustrating an example of the display screen W102 displayed on the display 140. The display screen W102 is, for example, a diagram illustrating an example of a display screen while a copy job involving the sheet feeding operation is executed. In an area R102 on the display screen W102, the same various icons as those in the area R100 of FIG. 7A are displayed in a light color in a state of being unselectable. In addition, the display screen W102 displays a copy stop button B104. Here, in a case where the copy job is completed, when the controller 100 detects contamination on the sensor during the copy job execution, the controller 100 displays the display screen W104 of FIG. 7C as the cover opening/closing request screen.

Further, when the user selects the copy stop button B104, for example, the controller 100 stops the job being executed, and displays the display screen W100 of FIG. 7A. Here, when detecting contamination on the sensor as in the case where the copy job is completed, the controller 100 displays the display screen W104 of FIG. 7C as the cover opening/closing request screen. As described above, unlike the display screen W100, even when the controller 100 detects contamination on the sensor while the display screen W102 is displayed, the controller 100 suppresses the display of the cover opening/closing request screen while the copy job involving the sheet feeding operation is executed (during the sheet feeding operation).

Note that here, while a job not involving the sheet feeding operation, for example, a scan job is executed, the feeder 14 does not operate. In this case, when detecting contamination on the sensor, the controller 100 displays the display screen W104 of FIG. 7C as the cover opening/closing request screen.

FIG. 7C is a diagram illustrating an example of the display screen W104 displayed on the display 140. The display screen W104 is a diagram illustrating an example of the cover opening/closing request screen. The display screen W104 displays a message M100 “CLEANING OF SENSOR IS NECESSARY. PLEASE OPEN AND CLOSE REAR COVER. CLEANING IS PERFORMED BY OPENING/CLOSING OPERATION”. Here, for example, when the user performs an operation of opening the cover 12, the controller 100 displays a display screen W106 of FIG. 7D on the display 140.

FIG. 7D is a diagram illustrating an example of the display screen W106 displayed on the display 140. The display screen W106 is a diagram illustrating an example of a display screen displayed on the display 140 with the cover 12 open, for example. The display screen W106 displays a message M102, “PLEASE CLOSE REAR COVER”. Here, for example, when the user performs an operation of closing the cover 12, the controller 100 displays the display screen W100 of FIG. 7A on the display 140.

Note that in the present embodiment, when the cover opening/closing request is made, the cover opening/closing request screen is displayed, but the controller 100 may display an image, a figure, or a text regarding the cover opening/closing request on the display screen W100, or may notify (inform) the user by voice or the like instead of the display. Alternatively, the controller 100 may display a notification regarding the cover opening/closing request, such as the cover opening/closing request screen or the like, on a display of another apparatus, for example, an information processing apparatus such as a terminal apparatus, via the communicator 170.

In this way, when detecting contamination on the sensor, the controller 100 can control the display of the message to be notified to the user in accordance with the state of the image forming apparatus. When detecting contamination on the sensor, the controller 100 determines whether the cover is in an openable/closable state or not from the state of the image forming apparatus, and notifies the user of the operation request (cover opening/closing request) when the cover is in the openable/closable state.

The controller 100 does not display and suppress the operation request for cleaning the sensor to prevent the user from opening the cover 12 by mistake, in a state in which contamination on the sensor is detected, and the cover 12 cannot be opened and closed such as during execution of a copy job, for example, in a state in which sheet feeding operation is executed such as “during copying”. Then, the controller 100 can display the operation request for cleaning the sensor in the state in which contamination on the sensor is detected, and the cover 12 is in the openable/closable state such as when an interval between copy jobs is reached during which the sheet feeding operation is stopped, and therefore, it is possible to cause the user to perform sensor cleaning without hindering the execution of the job involving the sheet feeding operation.

### 1.6 Effects, Etc.

The user can complete the sensor cleaning by the simple operations (opening and closing of the cover) at an appropriate timing (timing at which the cover can be opened and closed) at which the sheet feeding operation is stopped, without opening the cover by mistake at a timing at which the sheet feeding operation is executed such as during execution of a copy job, at which the cover cannot be opened and closed.

### 2. Second Embodiment

Hereinafter, a second embodiment will be described. The second embodiment is an embodiment in which cleaning of the sensor is completed by an operation of closing the cover 12 after removal of a jammed sheet, and the cover opening/closing request screen for the cover 12 for cleaning the sensor is not displayed.

In the second embodiment, the same hardware and software configurations as those of the first embodiment will not be described, and differences from the first embodiment will be mainly described.

### 2.1 Processing Flow

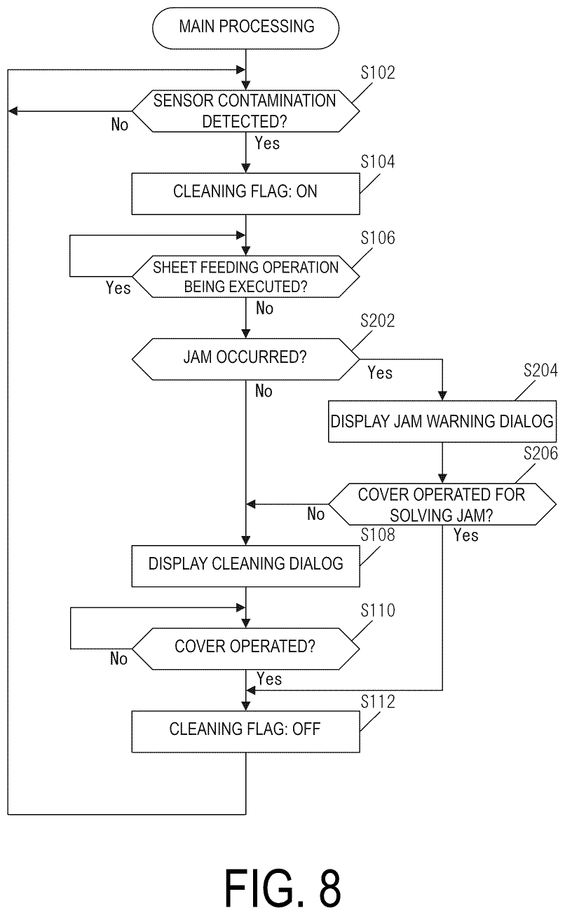

Hereinafter, a processing flow in the present embodiment will be described with reference to FIG. 8. FIG. 8 substitutes for FIG. 6 for the first embodiment. Between S106 and S108 in FIG. 6, S202 to S206 are executed.

When determining that the sheet feeding operation is not being executed, for example, the controller 100 determines whether a paper jam occurs or not (S106; No→S202). When a jam occurs, the controller 100 displays a display screen (a jam warning dialog) (S202; Yes→S204).

Subsequently, the controller 100 determines whether the cover 12 is operated to remove a jammed sheet, for example, in an operation for solving the jam or not, and executes processing S112 when it is determined that the cover 12 is operated (S206; Yes→S112), or displays the cover opening/closing request screen when it is determined that the cover 12 is not operated (S206; No→S108). Here, examples of a case where the cover 12 is not operated during the operation for solving the jam include a jam occurring in a document feeder such as an Automatic Document Feeder (ADF).

Note that the above-described operation flow is an example, and partially different processing may be performed. In the present embodiment, when it is determined that the sheet feeding operation is not being executed, whether a jam occurs or not is determined, but, for example, it may be determined whether the feeder 14 is out of paper or not before S202, and when the feeder 14 is not out of paper, the processing may proceed to S202, and when the feeder 14 is out of paper, the opening/closing request screen may be displayed (processing S110 is executed), and processing of displaying the out of paper may be executed after the cover 12 is operated.

### 2.2 Operation Example

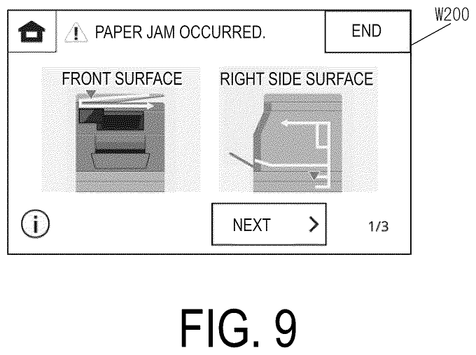

FIG. 9 is a diagram illustrating an example of a display screen W200 displayed on the display 140. The display screen W200 is a diagram illustrating an example of a display screen displayed on the display 140 when a job being executed is interrupted due to occurrence of a jam, for example. An operation explanation for solving the jam is displayed on the display screen W200. Here, for example, when the user performs an operation of opening the cover 12, the controller 100 displays the display screen W106 of FIG. 7D on the display 140.

In the present embodiment, the controller 100 displays the jam warning dialog as the display screen when a jam occurs even in a case where sensor contamination is detected, but for example, an image, a figure, or a text regarding the cover opening/closing request may be displayed on the display screen W200, or the user may be notified (informed) by voice or the like instead of the display. Alternatively, the controller 100 may display a notification regarding the cover opening/closing request, such as the cover opening/closing request screen or the like, on a display of another apparatus, for example, an information processing apparatus such as a terminal apparatus, via the communicator 170.

### 2.3 Effects, Etc.

In the image forming apparatus 10 including the sensor cleaning mechanism, when the user opens and closes the cover 12 for a purpose other than the cleaning of the sensor, for example, removing a jammed sheet, and the cleaning of the sensor is completed, the operation request for cleaning the sensor (the opening/closing request for the cover 12) is not notified again. This allows the user to complete the cleaning of the sensor without performing the opening/closing operation of the cover 12 again only for the purpose of cleaning the sensor.

### 3. Third Embodiment

Hereinafter, a third embodiment will be described. The third embodiment is an embodiment in which, when the controller 100 detects contamination on the sensor but the cover 12 cannot be opened and closed, for example, during a copy job involving the sheet feeding operation, an icon indicating that the contamination on the sensor is detected is displayed.

In the third embodiment, descriptions of the hardware and software configurations that are the same as those in the first embodiment are omitted, and the differences from the first embodiment are mainly described.

### 3.1 Processing Flow

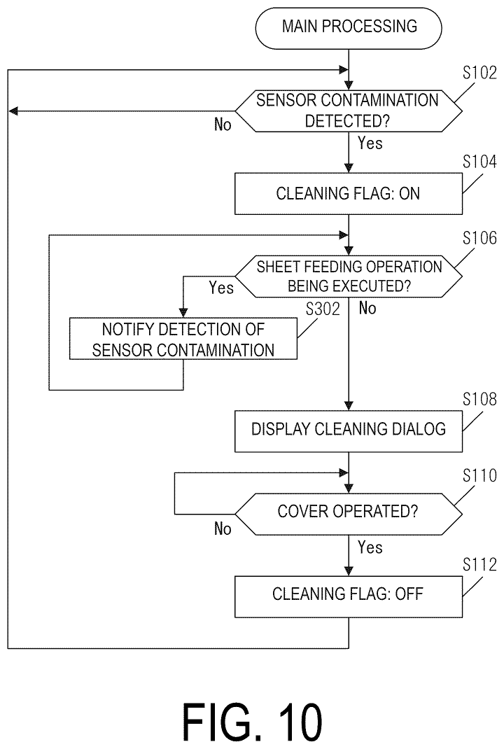

Hereinafter, a processing flow in the present embodiment will be described with reference to FIG. 10. FIG. 10 substitutes for FIG. 6 for the first embodiment. S302 is executed after S106 in FIG. 6.

When detecting contamination on the sensor but determining that the sheet feeding operation is being executed, the controller 100 executes, for example, a notification regarding the detection of the contamination on the sensor (S106; Yes→S302). Here, the controller 100 may display a contamination detection icon, as a method of executing the notification regarding the detection of the contamination on the sensor. The contamination detection icon may display, for example, an image, a graphic, a text, or the like, may only notify (inform) the user, or may be selectable by the user.

### 3.2 Operation Examples

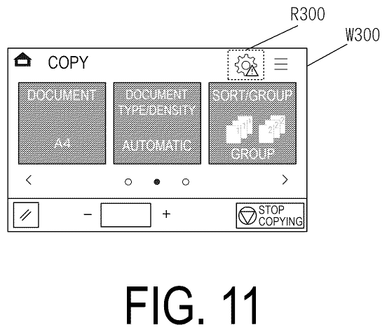

FIG. 11 is a diagram illustrating an example of a display screen W300 displayed on the display 140. The display screen W300 is a diagram illustrating an example of a display screen while a copy job is executed, for example. In the display screen W300, the various icons are displayed in a light color in the state of being unselectable, as in the area R102 of FIG. 7B. Further, the contamination detection icon is displayed in an area R300 on the display screen W300. Here, for example, when the controller 100 determines that the sensor needs to be cleaned in a case where a copy job involving the sheet feeding operation is completed, the controller 100 may display the display screen W104 of FIG. 7C as the cover opening/closing request screen.

In the present embodiment, the controller 100 displays the contamination detection icon on the display 140 while a job is executed to notify (inform) the user that the contamination on the sensor is detected, but for example, the user may select the contamination detection icon to display a method of cleaning the sensor 16a. As an example, when the user selects the contamination detection icon while a job operates, for example, the controller 100 executes processing of temporarily interrupting the copy job. Next, the controller 100 may display the cover opening/closing request screen on the display 140 in a state in which the copy job is stopped and the cover 12 is openable and closable, for example. Note that the controller 100 may execute processing that does not temporarily interrupt the copy job. When the user selects the contamination detection icon while the job operates, for example, the controller 100 displays a display screen on the display 140, and displays a message such as “CLEANING OF SENSOR IS NECESSARY. PLEASE OPEN AND CLOSE REAR COVER AFTER PRINTING IS COMPLETED. CLEANING IS PERFORMED BY OPENING/CLOSING OPERATION”.

As described above, even in a case where the controller 100 determines that the sensor needs to be cleaned, when the cover 12 is in a state of being unable to be opened and closed, such as during execution of a copy job, the controller 100 suppresses the display of the cover opening/closing request screen and displays the contamination detection icon different from the cover opening/closing request screen on the display screen in a superimposed manner. By displaying the contamination detection icon at a timing other than the timing at which the cover 12 can be opened and closed, it is possible to give a user a notice that the sensor 16a needs to be cleaned without hindering the execution of the job.

### 4. Variations

The disclosure is not limited to the above-described embodiments, and various modifications are possible.

In other words, embodiments obtained by combining technical mechanisms appropriately changed without departing from the gist of the disclosure are also included in the technical scope.

Although the above-described embodiments have been separately described for convenience of description, the embodiments can be combined and executed within an allowable range. The right of any of the technologies described herein is intended to be acquired through amendment, divisional application, or the like.

Further, in each embodiment, a program operating on the image forming apparatus is a program that controls a CPU or the like (a program for causing a computer to function) to enable the functions of the above-described embodiments. Information handled by these apparatuses is temporarily accumulated in a transitory storage apparatus (for example, a RAM) at the time of processing, is then stored in a storage apparatus such as any of various ROMs or an HDD, and is read, corrected, and written by the CPU as needed.

The recording medium storing the programs may be any of a semiconductor medium (for example, a ROM, a non-volatile memory card, or the like), an optical recording medium or a magneto-optical recording medium (for example, a Digital Versatile Disc (DVD), a Compact Disc (CD), a Blu-ray (trade name) Disc (BD) or the like), a magnetic recording medium (for example, a magnetic tape, a flexible disk, or the like), and the like.

In a case where the programs are distributed to market, the programs can be stored and distributed in a portable recording medium, or can be transferred to a server computer connected via a network such as the Internet. In this case, it is a matter of course that the storage apparatus of the server apparatus is also included in the disclosure.

Instead of being stored in the apparatus, the above-described data may be stored in an external apparatus and called as appropriate. For example, the data may be stored in a Network Attached Storage (NAS) or may be stored on a cloud.

It should be noted that the scope of the disclosure is not limited to the configurations explicitly described herein, and a combination of technologies disclosed herein is also included in the scope thereof. Configurations of the disclosure sought to be patented are set forth in the appended claims, but configurations not recited in the claims are not intended to be excluded from the technical scope.

In the above-described specification, the descriptions “in a case in which . . . ” and “when . . . ” are described as examples, and the configuration is not limited to the described contents. Configurations not indicated by the descriptions “in a case in which . . . ” and “when . . . ” are also disclosed to the extent that the configurations are obvious to a person skilled in the art, and the rights thereof are intended to be acquired.

The processing and the flow of data have been described herein in order, but the order thereof is not limited to the described order. For example, a configuration in which processing is partly removed or the order is rearranged is also disclosed, and the right thereof is intended to be acquired.

Although the functions described in the embodiments are described as being performed in the respective apparatuses, the functions may be enabled in one apparatus or using an external server.

In addition, each functional block or various features of the apparatus used in the above-described embodiments may be implemented or executed by an electric circuit such as, for example, an integrated circuit or a plurality of integrated circuits. An electric circuit designed to perform the functions described herein may include a general-purpose processor, a Digital Signal Processor (DSP), an Application Specific Integrated Circuit (ASIC), a Field Programmable Gate Array (FPGA) or other programmable logic device, discrete gate or transistor logic, discrete hardware components, or a combination thereof. The general-purpose processor may be a microprocessor or may be a processor, controller, microcontroller, or state machine of the related art. The electric circuit described above may be configured of a digital circuit or may be configured of an analog circuit. Further, when an integrated circuit technology for replacement into a current integrated circuit emerges with the development of semiconductor technology, a new integrated circuit based on the technology may also be used in one or more aspects of the disclosure.

### DESCRIPTION OF SYMBOLS

10 Image forming apparatus
12 Cover (Cover member)
12a Stopper member
14 Feeder (Feed tray)
16 Sensor holder unit
16a Sensor
16b Sensor holding member (Sensor holder)
18 Cleaning mechanism (Sensor cleaning mechanism)
18a Sensor cleaning plate
18b Cleaning pad
18c Sensor cleaning lever
100 Controller
110 Storage
120 ROM
130 RAM
140 Display
150 Operator
160 Image former
165 Image scanner
170 Communicator

1. An image forming apparatus, comprising:
a sensor;
a cleaning mechanism that cleans the sensor;
a display;
a job executor;
a detector that detects contamination on the sensor; and
one or more controllers that control display of a notification related to the cleaning of the sensor on the display by operation regarding a job executed by the job executor in a case where the detector detects contamination on the sensor.

2. The image forming apparatus according to claim 1, further comprising a feeder, wherein
the one or more controllers suppress the notification related to the cleaning of the sensor in a case where the operation regarding the job is an operation involving sheet feeding from the feeder.

3. The image forming apparatus according to claim 2, wherein
the one or more controllers suppress the notification related to the cleaning of the sensor even in a case where a jam occurs due to the operation involving the sheet feeding from the feeder, and the operation involving the sheet feeding from the feeder is interrupted.

4. The image forming apparatus according to claim 2, wherein
the one or more controllers display a notification indicating that contamination on the sensor is detected, that is different from the notification, on the display in a case where the operation regarding the job is the operation involving the sheet feeding from the feeder.

5. The image forming apparatus according to claim 1, comprising a cover member, wherein
the cleaning mechanism cleans the sensor by an opening operation and a closing operation of the cover member.

6. A display method in an image forming apparatus including a sensor and a cleaning mechanism that cleans the sensor, comprising:
(a) displaying;
(b) executing a job;
(c) detecting contamination on the sensor; and
(d) controlling, in a case where contamination on the sensor is detected in step (c), display on the display of a notification related to the cleaning of the sensor, by operation regarding a job executed in step (b).
